(19) United States
(12) Patent Application Publication
(10) Pub. No.: US 2026/0152696 A1
(43) Pub. Date: Jun. 4, 2026

(54) Apparatus and Methods for Enhancing Hydrocarbons by Catalytic Steam-Hydro Processing

(71) Applicant: Nanos Technology and Innovations Ltd., Calgary (CA)

(72) Inventors: Carlos Eduardo SCOTT, Calgary (CA); Florian ISUFAJ, Calgary (CA); Monica BARTOLINI TIBERI, Cochrane (CA); Gerardo VITALE ROJAS, Calgary (CA); Pedro Rafael PEREIRA ALMAO, Calgary (CA)

(21) Appl. No.: 19/122,249

(22) PCT Filed: Oct. 17, 2023
(86) PCT No.: PCT/CA2023/051375

§ 371 Date: Apr. 17, 2025

Related U.S. Application Data
(60) Provisional application No. 63/417,086, filed on Oct. 18, 2022.

(51) Int. Cl. C10G 45/04; B01J 8/02; B01J 21/04; B01J 23/83; B01J 27/22; C01B 3/046; C10G 45/26; C10G 47/12; C10G 47/32

(52) U.S. Cl. CPC C10G 45/04; B01J 8/0278; B01J 21/04; B01J 23/83; B01J 27/22; C01B 3/046; C10G 45/26; C10G 47/12; C10G 47/32; C10G 2300/202; C10G 2300/302; C10G 2300/308; C10G 2400/04

(57) ABSTRACT

Systems and methods for enhancing hydrocarbon feed fuels by using hydrogen and steam in the presence of hydroprocessing and steam catalysts within a catalytic reactor. Hydrogen can be generated and/or separated from a light gas product stream and recycled to the catalytic reactor to be used as a reactant. The catalytic reactor includes a combination of both a hydroprocessing catalyst and a steam processing catalyst. The hydroprocessing catalyst and the steam processing catalyst are each mounted directly onto a respective underlying support. The steam processing catalyst is a water splitting catalyst which facilitates the breaking of hydrogen-oxygen bonds in water to produce hydrogen. The hydroprocessing catalyst facilitates a reaction between the produced hydrogen and the hydrocarbon feed to produce hydrocarbon products

### RELATED APPLICATIONS

This claims priority from U.S. Provisional Application No. 63/417,086 filed on Oct. 18, 2022, which is hereby incorporated by reference in its entirety.

### TECHNICAL FIELD

The present disclosure relates to systems and methods for the enhancement or improvement of oils and hydrocarbon streams, using catalytic paths and steam as a hydrogen source.

### BACKGROUND

In the field of oil processing (fossil or renewable), a persistent and long-standing endeavour over several decades has been the pursuit of two principal objectives:
1. the conversion of heavy oils into lighter, more valuable products, and
2. the removal of undesirable contaminants, notably sulfur, nitrogen and oxygen compounds.

This dual quest has driven significant advancements in hydroprocessing technologies, leading to the production of cleaner, higher-quality fuels and feedstocks. However, in the modern era marked by a growing emphasis on environmental sustainability and the imperative to mitigate climate change, a new overarching goal has emerged. Contemporary processing facilities are now tasked with achieving these fundamental processes in a manner characterized by low carbon intensity, thereby contributing to the broader global imperative of decarbonizing the refining industry and reducing its overall carbon footprint. This paradigm shift underscores the critical need for innovative and environmentally responsible approaches that align with the evolving energy landscape and sustainability objectives.

Heavy (H), extra-heavy (XH) oil and natural bitumen are the result of degradation of conventional oil, mainly by bacterial action. They can be defined as petroleum or petroleum-like materials that are very viscous liquids or semisolids at reservoir conditions and are found naturally in porous and fractured media. Bitumen deposits are also called tar sand, oil sand or bituminous sand. These oils are characterised by their high viscosity, high density (low API gravity), and high concentrations of nitrogen, oxygen, sulphur, and heavy metals (Homayuni, F., Hamidi, A. A., and Vatani, A. 2012, Petroleum Science and Technology, 30).

In order to be transported and/or processed in refineries, H and XH oils and bitumen typically first require upgrading. Upgrading increases the oil value by producing higher quality conventional oil (synthetic crude oil, SCO). During the upgrading processes the API gravity of the oil is increased, the viscosity is reduced and sulfur, nitrogen, metal and aromatic content are also decreased, however, full upgrading to SCO requires very significant capital investment.

Also, to be transported heavy oils require additional treatments due to their large viscosities and low API gravity (see table 1).

TABLE 1
Heavy, extra heavy oil and bitumen.

| Type of oil | Viscosity/cp* | API gravity/** |
|---|---|---|
| Heavy | <10000 | 10-20 |
| Extra heavy | <10000 | <10 |
| Bitumen | >10000 | <10 |

*Viscosities are referenced to original reservoir temperature.
**API gravity = (141.5/Specific gravity)-131.5. Specific gravity is referenced to 15.6° C. (60 degrees ° F.) and atmospheric pressure.

These treatments most commonly consist of either heating or diluting the original oil with solvents to decrease the viscosity. Blending the heavy oils with a less viscous hydrocarbon, such as light crude oils, naphtha, kerosene and condensate, is common practice, however, as much as 30% in volume of diluents is usually needed. This dilution practice is problematic because of the necessity to increase pipeline capacity and the high costs of the diluents. Even though recycling of diluents can be a solution, a large investment to install a recovery process (e.g., distillation) and additional pipeline for transporting the solvent back to the production facilities is then required.

Partial upgrading has been defined (M. R. Gray. 2019. Energy Fuels. 33, 6483) as any combination of bitumen processing steps that reduce diluent addition to meet specifications for pipeline transport (table 2) (A. de Klerk. 2021. Energy Fuels, 35, 14343).

By reducing the amount of diluent, partial upgrading diminishes the load on pipelines resulting in lower operating expenses and capital costs relative to SCO production, while also decreasing the emissions related to transportation and recovery of diluent.

TABLE 2
Canadian pipeline specifications for Bitumen transport

| Property description | Maximum |
|---|---|
| Kinematic viscosity at pipeline temperature (mm² s⁻¹)^{a} | 350 |
| Density at 15.6° C. (Kg m⁻³) | 940 |
| Olefin content (wt. % as 1-decene equivalent)^{b} | 1 |

^{a}Pipeline temperature varies between 7.5 and 18.5° C.
^{b}Method based on ¹H-NMR measurement of olefinic hydrogen content.

Different partial upgrading processes have been proposed. Some of these processes in the previous art are based on thermal cracking (U.S. Pat. Nos. 8,871,081, 9,434,888, CA 3,100,011) producing olefins which may exceed the specification for pipeline transport. In addition, phase stability due to olefins may become a problem, and the density and viscosity of thermally converted materials may increase during storage.

Some technologies overcome this drawback by using hydrogen (CA 3,021,229, U.S. Pat. No. 10,358,610 B2), however the cost of hydrogen generation may not justify its used in the partial upgrading context (A. de Klerk, Energy Fuels, 2021, 35, 14343).

In addition, due to the high content of sulfur and nitrogen in heavy oils and bitumen, the fuels they produce contain higher amount of those heteroatoms compare to the ones produced from lighter oils, and their release into the atmosphere during the processing and end-use of petroleum products poses environmental and health related problems. In addition, sulfur impairs the effectiveness of emission control systems, for example, sulfur may poison catalytic converters used in automobiles, and is also partially responsible for soot emissions from trucks and buses because it tends to degrade the traps that are used on those vehicles.

In order to address the problems posed by sulfur emissions from fossil fuels many countries have imposed stringent sulfur emission standards. Treating fossil fuels to reduce the sulfur content to the levels required to meet such standards is difficult and expensive.

One important method for the desulfurization of fossil fuels in the prior art is hydrodesulfurization in which the fossil fuel is reacted with hydrogen at high temperatures and pressures in the presence of a catalyst. Conventional hydrotreating units installed worldwide are important consumers of hydrogen (more than 40% of the global H₂ demand—IEA Global Hydrogen Review 2022) and required pressures and temperatures which depend on the characteristics of the treated fossil fuel.

It is recognized that techniques effective for treating light fuel oils are not necessarily effective in removing sulfur from heavy fuel oils. That is, currently used processes including hydrodesulfurization (HDS) enable the removal of compounds such as sulfides, thiols and thiophenes from lighter fuels. For example, hydrodesulfurization of ethanethiol with hydrogen generates ethane and hydrogen sulfide:

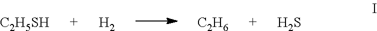

However, other sulfur compounds, including substituted condensed benzo-naphtho-thiophenes, are more difficult and costly to remove by hydrodesulfurization in both light and heavy fuels. Higher process severity, such as very high pressure, in addition to higher hydrogen consumption, are required for desulfurization of such molecules in conventional hydrotreating methods.

There is, therefore, a continuing need for methods to improve the quality of oils and hydrocarbon streams (renewable or fossil fuels), all while ensuring a commitment to lowering the carbon intensity in fuel producing processes.

### SUMMARY

In accordance with the present disclosure, there is further provided a process for enhancing a hydrocarbon feed, the process comprising;
processing the hydrocarbon feed with steam in a catalytic reactor to form an enhanced fuel, the catalytic reactor comprising a combination of both a hydroprocessing catalyst and a steam processing catalyst, the hydroprocessing catalyst and the steam processing catalyst each being mounted directly onto a respective underlying support;
wherein the steam processing catalyst is a water splitting catalyst which facilitates the breaking of hydrogen-oxygen bonds in water (e.g. in the form of steam) to produce hydrogen, and
wherein the hydroprocessing catalyst facilitates a reaction between the produced hydrogen and the hydrocarbon feed to produce hydrocarbon products.

In accordance with the present disclosure, there is further provided a process for the enhancement of quality of oils fuel, the process comprising:
treating the oil in a catalytic reactor to form a quality enhanced oil, the catalytic reactor comprising a combination of both a hydroprocessing catalyst (HDPC) and a steam processing catalyst (SPC).
wherein the hydroprocessing catalyst and the steam processing catalyst are each mounted directly onto an underlying support;
wherein the hydroprocessing catalyst facilitates a reaction between the hydrogen and hydrocarbon radicals or sulfur containing compounds to produce hydrocarbon products; and
wherein the steam processing catalyst facilitates the water dissociation reaction.

The hydrocarbon feed may comprise higher molecular weight hydrocarbons, and the hydroprocessing catalyst may facilitate an upgrading reaction between the produced hydrogen and the higher molecular weight hydrocarbons to produce lower molecular weight hydrocarbon products.

The hydrocarbon feed may comprise oxidised nitrogen-containing hydrocarbons, and the hydroprocessing catalyst may facilitate a reaction between the produced hydrogen and the oxidised nitrogen-containing hydrocarbons to produce the hydrocarbon products and nitrogen oxides. Oxidised nitrogen-containing hydrocarbons may comprise organic molecules having a nitrogen-oxygen bond (e.g., where a nitrogen atom is bonded directly to an oxygen atom).

The hydrocarbon feed may comprise non-oxidised nitrogen-containing hydrocarbons, and wherein the hydroprocessing catalyst facilitates a reaction between the produced hydrogen and the non-oxidised nitrogen-containing hydrocarbons to produce the hydrocarbon products and ammonia. Non-oxidised nitrogen-containing hydrocarbons may comprise organic molecules having one or more nitrogen atoms bonded only to carbon and/or hydrogen atoms.

The catalytic reactor may comprise a reactor vessel with one or more inlets for receiving reactant feeds (e.g., water, hydrocarbon feed and/or recycled hydrogen) and one or more outlets for removing a product feed. The reactor vessel may comprise walls defining a volume within which there are placed beds of the hydroprocessing and steam reforming catalyst.

In the context of this disclosure, the term enhancing may relate to improving the quality of a hydrocarbon feed. In particular, enhancing a hydrocarbon feed may comprise one or more of: reducing viscosity of the hydrocarbon feed, increasing API gravity of the hydrocarbon feed, decreasing heteroatoms content (e.g., atoms other than hydrogen and carbon, such as S, N, O and metals) of the hydrocarbon feed, reducing MCR of the hydrocarbon feed, and reducing asphaltenes in the hydrocarbon feed, and increasing H/C ratio of the hydrocarbon feed. An enhanced hydrocarbon may comprise only hydrogen and carbon atoms. An enhanced hydrocarbon may comprise a hydrocarbon product of a reaction in which at least one non-hydrogen, non-carbon atom has been removed (e.g., a sulfur, nitrogen and/or oxygen atom).

The process may desulfurize and/or denitrogenate a previously oxidized hydrocarbon. The process may comprise producing gases comprising at least one non-hydrogen, non-carbon atom. The product gases may comprise one or more of: ammonia, nitrogen oxide (NOx), hydrogen sulfide, sulfur oxide (SOx). Nitrogen oxide may comprise nitric oxide (NO) and/or nitrogen dioxide (NO₂).

In the context of this disclosure, a hydrocarbon molecule may comprise more carbon and hydrogen atoms than other atoms. A hydrocarbon molecule may comprise mainly carbon and hydrogen atoms. A hydrocarbon may be an aliphatic compound. A hydrocarbon may be an aromatic compound. A hydrocarbon molecule may comprise a cyclic ring. A cyclic ring may be a heterocyclic ring. A hydrocarbon molecule may be considered to be an organic compound. An organic compound may be any chemical compound that contains carbon-hydrogen or carbon-carbon bonds. A pure hydrocarbon molecule may consist entirely of hydrogen and carbon. The hydrocarbon feed may comprise pure hydrocarbons.

The process may comprise treating an oxidized hydrocarbon stream in a catalytic reactor to form a desulfurized stream, the catalytic reactor comprising a combination of both a hydroprocessing catalyst (HDPC) and a steam processing catalyst (SPC).

The steam processing catalyst may facilitate the reaction between the steam and the sulfur containing compounds to produce hydrocarbons products.

The process may comprise processing bio-oils, bitumen/heavy oil without previous fractionation, visbreaking, thermal or steam cracking, or other additional viscosity reductions steps. The process may be performed at low pressure. The process may not require the use of an external source of hydrogen. External source of hydrogen refers to hydrogen supplied as a feed to the reactor which does not include hydrogen present in the feedstock and/or produced in the reactor (e.g., including recycled hydrogen produced by the reactor), and/or produced by the reforming of hydrocarbons produced in the reactor. I.e., the hydrogen used in the reactor vessel may consist of one or more of the following: hydrogen present in the raw hydrocarbon feed, hydrogen produced by the steam processing catalyst from water, hydrogen produced by reforming hydrocarbons in the raw hydrocarbon feed, and hydrogen produced by reforming hydrocarbons produced in the catalytic reactor.

In the context of this disclosure, an oxidized hydrocarbon may mean, but not be limited to, a hydrocarbon stream that is previously submitted to an oxidation process. Examples of this oxidation step may include the methods used in conventional oxidative desulfurization, where the hydrocarbons are oxidized and sulfur compounds are in particular oxidized to their respective sulfones.

Oxidized oils containing sulfones may be easier to desulfurize in the process of the present disclosure, compared to non-oxidized sulfur compounds (like thiophenes, benzo-thiophenes and di-benzo-thiophenes). Such feature is related to the fact that in the sulfones/sulfoxides the sulfur-carbon bonds are weakened with respect to the original thiophenic compounds.

The hydroprocessing catalyst and the steam processing catalyst may be mounted onto different supports. A support is the material, usually a solid with a high surface area, to which an active and selective catalytic phase (or phases) is affixed.

The hydroprocessing catalyst and the steam processing catalyst may be blended on the same bed within the catalytic reactor (e.g., while each being directly mounted onto the underlying support).

The hydroprocessing catalyst and the steam processing catalyst may be mounted on separate beds within the catalytic reactor.

The hydroprocessing catalyst may comprise a metallic carbide or mixed metallic carbides.

The hydroprocessing catalyst may comprise one or more of: metallic oxy-carbides, metallic nitrides, and metallic phosphides.

The hydroprocessing catalyst may comprise a combination of one or more of: molybdenum, tungsten, nickel and cobalt.

The hydroprocessing catalyst may comprise molybdenum carbide supported on a support. The support may be alumina in any of its crystalline or amorphous forms.

The hydroprocessing catalyst may be impervious to water.

The steam processing catalyst may comprise hydrotalcite precursors or mixed oxides or combinations of the ones listed:

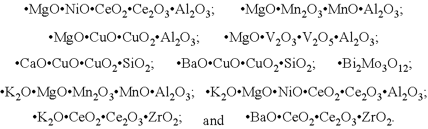

The feed to be treated with the catalytic reactor disclosed herein may be an oxidized hydrocarbon fuel, a bio-oil of any origin, a partially diluted oil, bitumen or heavy oil, or a topped oil.

The feed may be treated in the catalytic reactor at a temperature in the range of from 250° C. to 500° C.

The feed may be treated in the catalytic reactor at pressures in the range from 250 psig to 1200 psig, preferably between 300 and 600 psig. The hydrocarbon feed may be treated in the catalytic reactor at a Weight Hourly Space Velocity in the range from 0.1 h⁻¹ to 10 h⁻¹. Weight hourly space velocity (WHSV) may be defined as the mass flow rate of the hydrocarbon feed fed to the reactor, divided by the mass of catalyst in the catalytic reactor.

The proportion of steam processing catalyst as a proportion of the combination of the hydroprocessing catalyst and the steam processing catalyst may be between 5 wt. % and 95 wt. %.

In a preferred embodiment of the present disclosure, the proportion of steam processing catalyst as a proportion of the combination of the hydroprocessing catalyst and the steam processing catalyst may be between 50 wt. % and 90 wt. %.

The output from the catalytic reactor may be separated into an enhanced quality/desulfurized/upgraded fuel stream and a gas stream, the gas stream comprising one or more of: sulfur and nitrogen containing gases, carbon dioxide, hydrogen, light hydrocarbons and water.

The gas stream may be further separated into a recycle stream and a non-recycle stream, wherein the recycle stream comprising one or more of: hydrogen and light hydrocarbons, and wherein the recycle stream is injected into the catalytic reactor. The non-recycle stream may comprise one or more of: sulfur containing gases, carbon dioxide and water.

The gas stream may be partially separated and recycled after convectional processing to reuse the produced/non-consumed hydrogen.

Hydrocarbon gases produced and light naphtha streams may be steam reformed to generate additional hydrogen before being injected into the catalytic reactor. The steam reforming may be performed as per International PCT Patent Application WO 2023/178418, which is hereby incorporated by reference in its entirety.

Light naphtha may have a fraction boiling between 30° C. and 90° C. Light naphtha may consist of molecules with 5-6 carbon atoms.

The hydroprocessing catalyst and the steam processing catalyst may form separate domains within the catalytic reactor.

The steam processing catalyst may be a water splitting catalyst configured to catalyse the breaking of hydrogen-oxygen bonds in water to produce hydrogen.

The hydroprocessing and steam processing catalysts may each have a porosity in the range of 6-50 nm.

The hydrocarbon fuel may have a sulfur content greater than 0.5 wt %. The hydrocarbon fuel may have a sulfur content less than 0.5 wt %.

The hydroprocessing catalyst and/or the steam processing catalyst may have a surface area in the range between 40 and 80 m²·g⁻¹. The hydroprocessing catalyst and/or the steam processing catalyst may have a surface area in the range between 40 and 120 m²·g⁻¹. Surface areas may be measured by BET (Brunauer, Emmett and Teller) surface area, e.g., measured by nitrogen physisorption techniques.

The hydroprocessing catalyst and/or the steam processing catalyst may have a BJH Pore volume in the range between 0.3 and 0.5 cm³/g. The hydroprocessing catalyst and/or the steam processing catalyst may have a BJH Pore size (e.g., diameter) in the range between 7 and 25 nm.

The process of the present disclosure may be controlled to form an upgraded oil with a viscosity of 250 cP or less.

The process may be controlled to form an upgraded oil with an API gravity of 19 or more.

The hydrocarbon feed may be a hydrocarbon fuel.

The oxidized hydrocarbon fuel that can be treated within the process may have a sulfur content greater than 0.5 wt %. The hydrocarbon fuel that can be treated within the process may have a sulfur content greater than 0.5 wt %.

The process may be controlled to form a desulfurized fuel having a sulfur content less that 0.5 wt %.

The hydroprocessing catalyst may contain a different chemical active phase than the steam processing catalyst.

The hydroprocessing catalyst may comprise one or more of: a metallic carbide, an oxy-carbide, a nitride, and a phosphide. The structure of the hydroprocessing catalyst may comprise amorphous regions, nano-crystalline regions (e.g., with a domain size of less then 50 nm) or a mixture of both.

The steam processing catalyst may comprise a combination of oxides. The structure of the steam processing catalyst may comprise amorphous regions, nano-crystalline regions (e.g., with a domain size of less then 50 nm) or a mixture of both.

In the context of this disclosure, an oxidized compound (e.g., hydrocarbon) is a compound containing oxygen.

In the context of this disclosure, a sulfurized compound is a compound (e.g., hydrocarbon) containing sulfur.

In the context of this disclosure, a catalyst being impervious to water may be considered to mean that it can continue to operate as a catalyst (e.g., a hydroprocessing catalyst) in the presence of water (e.g., steam). That is, the catalyst may not react with, irreversibly bond with, be deactivated by, and/or change state (e.g., dissolve) in the presence of water (e.g., steam).

The process may be operated continuously.

In the context of this disclosure, a sulfone may be considered to be a chemical compound containing a sulfur atom doubly bonded to two oxygen atoms, and singly bonded to two carbon atoms.

In the context of this disclosure, a sulfoxide may be considered to be a chemical compound containing a sulfinyl (SO) functional group attached to two carbon atoms.

The process may comprise submitting the feed to conditions where thermal/catalytic cracking is performed under the presence of steam, and where water splitting on the steam processing catalyst results in the production of hydrogen radicals:

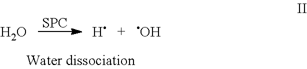

Thermal cracking produces hydrocarbon radicals:

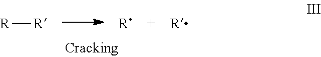

In the absence of hydrogen, there is hydrocarbon radical recombination, for example:

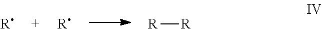

and olefin formation, for example:

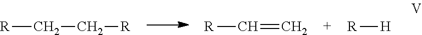

An olefin is compound made up of hydrogen and carbon that contains one or more pairs of carbon atoms linked by a double bond. Olefins are examples of unsaturated hydrocarbons.

Hydrogen radicals (H^{⋅}) may be formed by water splitting on the steam processing catalyst. The hydrogen radicals may saturate the hydrocarbon radicals produced by the thermal/catalytic cracking. The hydrogenation reaction being catalyzed by the hydroprocessing catalyst (HDPC):

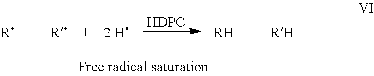

Hydrogen radicals may also react to produce molecular hydrogen:

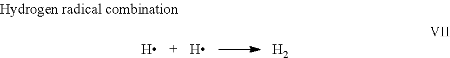

Molecular hydrogen may hydrogenate unsaturated hydrocarbons, in particular aromatic hydrocarbons. The hydrogenation reaction being catalyzed by the hydroprocessing catalyst:

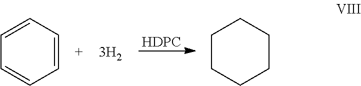 [SMILES: c1ccccc1 ; "HDPC" ; C1CCCCC1]

The steam processing catalyst may facilitate the water gas shift reaction in which carbon monoxide and steam are reacted to form carbon dioxide and hydrogen:

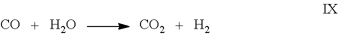

The steam processing catalyst may facilitate decarboxylation in which a carboxylic acid is reacted with steam to produce an enhanced hydrocarbon, carbon dioxide and hydrogen:

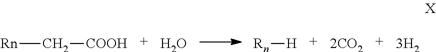

The steam processing catalyst may comprise cerium oxide. The steam processing catalyst may comprise a nickel cerium oxide catalyst.

The decomposition of steam on the steam processing catalyst may occur through water dissociation. For example, it may occur on ceria (CeO₂) within a Ni-Ceria catalyst:

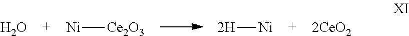

While CeO₂ can, at the reaction conditions, revert to Ce₂O₃, it may also catalyse oxidizing reactions of sulfur compounds to higher oxidated sulfur compounds (e.g., SO and SO₂). For example:

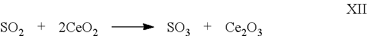

These sulfur oxides can be reduced by hydrogen to form water and hydrogen sulfide. For example:

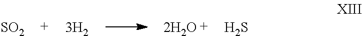

Hydrogen transfer from the hydrocarbons could also stimulate significantly this sulfur reduction.

According to a further aspect, there is provided a method for enhancing the quality of hydrocarbons (bio-oils and/or fossil fuels) forming an upgraded product.

The removal of sulfur and nitrogen may be more efficient when the feed is previously oxidized.

According to a further aspect, there is provided a method for upgrading heavy oil and bitumen (topped or not), forming an upgraded oil complying with pipeline specifications, by subjecting the said heavy oil or bio-oil or bitumen (topped or not) to one or more of:
a steam catalytic decomposition process (Steam Decomposition Process-SDP),
a hydro-steam catalytic treatment process (Hydrogen-Steam Decomposition Process-HSDP).

In accordance with a further aspect, there is provided a method for desulfurization and denitrogenation of fossil fuels containing sulfur and nitrogen that have been previously oxidized and comprising:
forming a desulfurized fuel by subjecting the oxidized fossil fuels to one or more of:
   a steam catalytic decomposition process (Steam Decomposition Process-SDP),
   a hydro-steam catalytic sulfones decomposition process (Hydrogen-Steam Decomposition Process-HSDP).

The Steam Decomposition Process may be one where no additional hydrogen is added to the reactor. However, there may be hydrogen produced within the reactor during the process by water splitting.

The Hydrogen-Steam Decomposition Process refers to the processing with steam and addition of hydrogen.

The reactor may have two catalysts: one catalyst with a hydrotreating-hydrogenation function and a second catalyst with a water splitting function.

Forming the final hydrocarbon product may include processing the hydrocarbon feed through a catalytic reactor having a reducing/hydroprocessing catalyst selected from metallic carbides, oxy-carbides, nitrides, and phosphides and mixtures thereof.

Forming a desulfurized fuel may include recycling the gases produced from the steam catalytic reactor, which contains hydrogen, to the inlet of the reactor. Before the gases are recycled, carbon dioxide and sulfur and nitrogen containing gases (e.g., H₂S and NH₃) may be separated or eliminated.

Forming the upgraded hydrocarbon may include directing the gases produced in the catalytic reactor to a separator, where hydrogen is separated from the rest of the gases and recycled to the inlet of the reactor. Before the hydrogen is isolated, carbon dioxide and sulfur and nitrogen containing gases (e.g., CO₂, H₂S, NH₃) may be separated or eliminated from the gas stream produced by the catalytic reactor.

Forming the upgraded hydrocarbon may include processing the feed through a catalytic reactor having a hydroprocessing catalyst. The hydroprocessing catalyst may comprise metallic carbide and/or nitride and/or phosphide. In particular, carbides, in general, are resistant to water. The hydroprocessing catalyst may be molybdenum carbide and/or tungsten carbide.

Forming the upgraded hydrocarbon may include processing the feed through a catalytic reactor having a steam processing catalysts selected from bi-, tri-, tetra- or penta-metallic oxides. The steam processing catalyst may comprise a combination of one or more of:
elements from and/or oxides of groups 1 and 2 including Na, K, Cs, Ca, Mg or Ba;
elements from and/or oxides of groups 4, 5, 6, 7, 8, 9, 10, and 11, including Ti, V, Cr, Mn, Fe, Co, Ni, Cu, Mo, Zr or Ce; and
elements from and/or oxides of groups 13, 14 and 15 including Al, Si, P or Bi.

The steam processing catalyst maybe selected hydrotalcite precursors or mixed oxides from any one or a combination of:

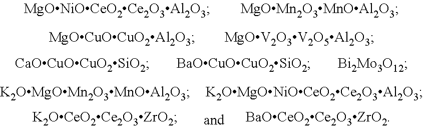

The catalysts may have multiple functions. A steam processing catalyst (e.g., NiCe/Al₂O₃) may have a water splitting function which is responsible for the production of hydrogen. A hydroprocessing catalyst (e.g., Mo₂C) may promote reactions with the hydrocarbons where hydrogen is a reactant (as opposed to a product).

Having separated catalysts for each function directly mounted onto the supports means that the addition of particular components of the catalyst does not affect the other components. For example, if a steam processing catalyst (e.g., NiCe/Al₂O₃) is simply impregnated or coated with a component (e.g., Mo₂C) with a hydrogenating function, the impregnated or coated component (Mo₂C) may block the steam processing active sites (e.g., of the NiCe). This can create an upper limit in the amount of Mo₂C that can be added without losing the water splitting efficiency of the catalyst (e.g., an upper limit of 10 wt % of hydroprocessing catalyst relative to the total catalyst).

The inventors have found that by having a combined catalytic bed or beds where the steam processing catalyst (e.g., NiCe with a water splitting function) and the hydrogenating catalyst (e.g., Mo₂C) are each mounted directly onto separated underlying supports, the total amount of the hydrogenating catalyst that can be loaded can be higher and the process is more efficient and more stable. For some embodiments of the present disclosure, the inventors have discovered that 30 wt % of the hydrogenating catalyst relative to the total steam and hydroprocessing catalysts provides improved performance.

A said support may be selected from any one or the combination of alumina, silica and modified kaolin (e.g., with controlled textural properties).

The catalyst may have a surface area in the range between 30 and 400 m²/g. Surface area may be determined using standard instruments based on nitrogen adsorption.

The catalyst may have a porosity in the range of 6-50 nm. Porosity may be determined using standard instruments based on nitrogen adsorption.

Forming a desulfurized fuel may include the oxidizing the sulfurized hydrocarbon using an oxidizing catalyst, prior to a desulfurizing step.

The oxidizing catalyst may be one or more of: formic acid and acetic acid.

An oxidized oil/water emulsion effluent resulting from the formation of the desulfurized fuel may be subjected to aqueous phase removal to separate gases, aqueous phase and the oxidized sulfone rich hydrocarbon.

An aqueous phase resulting from the formation of the desulfurized fuel may be further separated to recover oxidizing catalyst and water.

In another embodiments, the feed for the desulfurizing steps includes a water from the oxidation step.

The feed for forming the upgraded oil may be a bitumen or heavy oil (topped or not). After the steam processing and hydroprocessing, the reactor effluent or output may be subjected to a high temperature separation process to form the upgraded oil and a gaseous stream containing any one of or a combination of sulfur containing gases, nitrogen containing gases, carbon dioxide, steam, hydrogen, and light hydrocarbons.

The feed for forming the upgraded oil may be a topped bitumen or heavy oil or a bio-oil and where after the steam processing and hydroprocessing, the reactor effluent is subjected to a high temperature separation process to form the enhanced quality oil and a gaseous stream containing any one of or a combination of sulfur containing gases, nitrogen containing gases, carbon dioxide, steam, hydrogen, and light hydrocarbons. And where, when topped oil is used, the upgraded oil may be combined with the light fraction from the topping unit to reduced further the viscosity and increase the API gravity of the upgraded oil.

The feed for forming the desulfurized fuel may be an oxidized sulfone-rich hydrocarbon and where after the steam processing and hydroprocessing, a sulfone-free effluent is subjected to a high temperature separation process to form the desulfurized fossil fuel and a gaseous stream containing any one of or a combination of sulfur containing gases, carbon dioxide, steam, hydrogen and light hydrocarbons.

The gas stream may be sent to a separation process where carbon dioxide, sulfur and nitrogen containing compounds are separated from light hydrocarbons and hydrogen to obtain a hydrogen rich gas which may be recycled to the catalytic reactor.

A light hydrocarbons stream may be submitted to steam reforming, like as per International PCT Patent Application WO 2023/178418, and the hydrogen rich gas produced is recycled to the catalytic reactor.

Light hydrocarbons may comprise one or more of: methane, ethane, propane and butane.

In the context of this disclosure, standard temperature, T, and pressure, P, corresponds to T=0° C. (273.15 K) and P=1.01 bar (14.72 psia).

The H₂ may be recirculated to the catalytic reactor in the range from 20 std.cm³/cm³ of oil to about 200 std.cm³/cm³ of oil.

The H₂ may be recirculated to the catalytic reactor in the range of from 90 std.cm³/cm³ of oil to about 150 std.cm³/cm³ of oil.

According to a further aspect, there is provided a process for upgrading bitumen or heavy oil (topped or not), the process comprising:
treating the oil with steam and hydrogen in a catalytic reactor to form an upgraded pipelinable oil, the catalytic reactor comprising a combination of both a hydroprocessing catalyst and a steam processing catalyst,
wherein the hydroprocessing catalyst facilitates a reaction between the hydrogen and the oil compounds to produce lighter hydrocarbon products; and
wherein the steam processing catalyst facilitates a reaction between the steam and hydrocarbon compounds to produce hydrocarbons products; and
wherein an output from the catalytic reactor is separated into an upgraded oil stream and a gas stream, the gas stream comprising one or more of: sulfur containing gases, carbon dioxide, hydrogen, light hydrocarbons and water:
wherein the recycle stream is further separated to produce a hydrogen rich stream; and
wherein the hydrogen rich stream is injected into the catalytic reactor.

According to a further aspect, there is provided an apparatus for upgrading bio-oil, heavy oil or bitumen (topped or not), the apparatus comprising;
a catalytic reactor comprising a combination of both a hydroprocessing catalyst and a steam processing catalyst, wherein the hydroprocessing catalyst facilitates a reaction between the hydrogen and the oil to produce hydrocarbon products; and wherein the steam processing catalyst facilitates a reaction between the steam and the oil to produce hydrocarbons products; and
a separator configured to separate a recycle stream from the output of the catalytic reactor, the recycle stream comprising one or more of: hydrogen and light hydrocarbons.

The recycle line may comprise a steam reformer, like as per International PCT Patent Application WO 2023/178418, configured to react the light hydrocarbons with steam to generate hydrogen.

According to a further aspect, there is provided a catalytic reactor for upgrading heavy oil, bio-oil or bitumen (topped or not), the catalytic reactor comprising:
a combination of both a hydroprocessing catalyst and a steam processing catalyst,
wherein the hydroprocessing catalyst and the steam processing catalyst are each mounted directly onto an underlying support;
wherein the hydroprocessing catalyst facilitates a reaction between the hydrogen and the oil compounds to produce hydrocarbon products; and
wherein the steam processing catalyst facilitates a reaction between the steam and the oil compounds to produce hydrocarbons products.

According to a further aspect, there is provided a process of generating a catalyst bed for upgrading of bio-oil heavy oil or bitumen (topped or not), the process comprising;
distributing a hydroprocessing catalyst precursor and a steam processing catalyst precursor on a support,
activating the hydroprocessing catalyst precursor and the steam processing catalyst precursor at the same time to form a hydroprocessing catalyst and a steam processing catalyst,
wherein the hydroprocessing catalyst and the steam processing catalyst are each mounted directly onto the underlying support;
wherein the hydroprocessing catalyst facilitates a reaction between the hydrogen and the oil compounds to produce hydrocarbon products; and
wherein the steam processing catalyst facilitates a reaction between the steam and the sulfur containing compounds to produce hydrocarbons products.

According to a further aspect, there is provided a process for desulfurization of an oxidized hydrocarbon fuel, the oxidized hydrocarbon fuel being an organic phase comprising sulfur containing compounds including one or more of: a sulfone and a sulfoxide, the process comprising;
treating the oxidized hydrocarbon fuels with steam and hydrogen in a catalytic reactor to form a desulfurized fuel, the catalytic reactor comprising a combination of both a hydroprocessing catalyst and a steam processing catalyst,
wherein the hydroprocessing catalyst facilitates a reaction between the hydrogen and the sulfur containing compounds to produce hydrocarbon products; and
wherein the steam processing catalyst facilitates a reaction between the steam and the sulfur containing compounds to produce hydrocarbons products; and
wherein an output from the catalytic reactor is separated into a desulfurized fuel stream and a gas stream, the gas stream comprising one or more of: sulfur and nitrogen containing gases, carbon dioxide, hydrogen, light hydrocarbons and water;
wherein the gas stream is further separated into a recycle stream and a non-recycle stream, wherein the recycle stream is further separated to produce a hydrogen rich stream; and
wherein the hydrogen rich stream is injected to the catalytic reactor.

According to a further aspect, there is provided an apparatus for desulfurization of an oxidized hydrocarbon fuel, the oxidized hydrocarbon fuel being an organic phase comprising sulfur containing compounds including one or more of: a sulfone and a sulfoxide, the apparatus comprising;
a catalytic reactor comprising a combination of both a hydroprocessing catalyst and a steam processing catalyst, wherein the hydroprocessing catalyst facilitates a reaction between the hydrogen and the sulfur containing compounds to produce hydrocarbon products; and wherein the steam processing catalyst facilitates a reaction between the steam and the sulfur containing compounds to produce hydrocarbons products;
a separator configured to separate a recycle stream from the output of the catalytic reactor, the recycle stream comprising one or more of: hydrogen and light hydrocarbons; and
a recycle line configured to inject the recycle stream from the separator into the catalytic reactor.

The recycle line may comprise a steam reformer, like as per International PCT Patent Application WO 2023/178418, configured to react the light hydrocarbons with steam to generate hydrogen.

According to a further aspect, there is provided a catalytic reactor for desulfurization of an oxidized hydrocarbon fuel, the oxidized hydrocarbon fuel being an organic phase comprising sulfur containing compounds including one or more of: a sulfone and a sulfoxide, the catalytic reactor comprising;
a combination of both a hydroprocessing catalyst and a steam processing catalyst,
wherein the hydroprocessing catalyst and the steam processing catalyst are each mounted directly onto an underlying support;
wherein the hydroprocessing catalyst facilitates a reaction between the hydrogen and the sulfur containing compounds to produce hydrocarbon products; and
wherein the steam processing catalyst facilitates a reaction between the steam and the sulfur containing compounds to produce hydrocarbons products.

According to a further aspect, there is provided a process of generating a catalyst bed for desulfurization of an oxidized hydrocarbon fuel, the oxidized hydrocarbon fuel being an organic phase comprising sulfur containing compounds including one or more of: a sulfone and a sulfoxide, the process comprising;
distributing a hydroprocessing catalyst precursor and a steam processing catalyst precursor on a support,
activating the hydroprocessing catalyst precursor and the steam processing catalyst precursor at the same time to form a hydroprocessing catalyst and a steam processing catalyst,
wherein the hydroprocessing catalyst and the steam processing catalyst are each mounted directly onto the underlying support;
wherein the hydroprocessing catalyst facilitates a reaction between the hydrogen and the sulfur containing compounds to produce hydrocarbon products; and
wherein the steam processing catalyst facilitates a reaction between the steam and the sulfur containing compounds to produce hydrocarbons products.

Distributing a hydroprocessing catalyst precursor and a steam processing catalyst may comprise impregnating the support with the catalyst precursor.

At least one of the respective supports (e.g., for the hydroprocessing catalyst and or steam processing catalyst) may be alumina, silica, silica-alumina, clays or combinations of them in any of their crystalline or amorphous forms.

After the impregnation of the support (e.g., alumina) with the hydroprocessing catalyst (e.g., Mo₂C), the hydroprocessing catalyst may be activated in the reactor (e.g., along with the steam processing one) by reduction with hydrogen.

The steam processing catalyst may be calcined before the activation in the reactor of the hydroprocessing catalyst.

Bio-oil may be a biofuel obtained from thermochemical conversion of biomass, such as pyrolysis and hydrothermal liquefaction.

MCR may be tested using Standard Test Method for Determination of Carbon Residue (Micro Method), ASTM D4530-15 (2020).

Regarding the size of the nanocrystalline domain size, the sizes may be considered to relate to an “average three-dimensional size”. There may be no apparent preferential orientation of the oxides in the X-ray diffraction pattern.

The size of the nanocrystalline domain size is calculated using the Scherrer equation (e.g., via x-ray diffraction, XRD). There may not be a visible preferential growth of the crystals in the X-ray diffraction pattern. The conventional shape factor of 0.9 may be used as implemented in the software.

In the context of this disclosure, barg refers to gauge pressure in bar. E.g., 2 barg is equivalent to a gauge pressure of 2 bars. Gauge pressure is the pressure measured relative to the ambient atmospheric pressure. Ambient atmospheric pressure is typically 1.013 bar.

The total acid number (or TAN) of a crude oil is a measure of the corrosiveness of the crude due to the presence of acids (e.g., naphthenic acids). TAN is measured based on the mg of potassium hydroxide required to neutralize one gram of the feed. Generally, an acid number of over 1 is considered high.

### BRIEF DESCRIPTION OF THE DRAWINGS

Various objects, features and advantages of the present disclosure will be apparent from the following description of particular embodiments of the present disclosure, as illustrated in the accompanying drawings. The drawings are not necessarily to scale, emphasis instead being placed upon illustrating the principles of various embodiments of the present disclosure. Similar reference numerals indicate similar components.

FIG. 1 is a schematic flow diagram and reactor sequence for enhancing hydrocarbons in accordance with an embodiment of the present disclosure.

FIG. 2a is a schematic flow diagram and reactor sequence for enhancing hydrocarbons in accordance with a further embodiment of the present disclosure.

FIG. 2b is a schematic flow diagram and reactor sequence for an upgrading of topped heavy oil or bitumen in accordance with another embodiment of the present disclosure.

FIG. 3 shows the infra red spectra of the feedstock and products of Example 4: Diesel C, Oxidized Diesel C and the desulfurized product obtained using the present disclosure. The formation of sulfones after the oxidation is observed. The complete disappearing of the sulfones in the desulfurized hydrocarbon product obtained using the present disclosure is clearly seen.

### DETAILED DESCRIPTION

### Introduction

An objective of the technology disclosed herein is to address, in various embodiments, both the conversion of heavy oils of any origin into lighter streams and fuels and the deoxygenation, denitrogenation and desulfurization of hydrocarbon streams, such as diesel or gasoil, while replacing or reducing the need of expensive hydrogen and reduction of capital expenses, all usually translating into lower emissions.

The present technology relates to systems and methods for quality improvements of hydrocarbons streams to produce an upgraded product, and where the upgraded product may have a viscosity and an API gravity, that complies with pipeline specifications, which substantially reduces or eliminates the needed addition of diluent.

The embodiments under several configurations in this present disclosure make use of fixed bed reactors using catalysts that effectively activate water (as steam) at moderate conditions, reducing or eliminating conventional thermal cracking paths, thus avoiding and reducing or eliminating undesirable by products such as asphaltenes and olefins while minimizing gases, taking instead advantage of the hydrocarbon gases, in our embodiments, the low pressure of the reaction zone vessels may be in the case of processing heavy oils less than 35 barg for steam processing vs between 50 to 120 barg for hydroprocessing vessels. These features are significant cost advantages for catalytic steam processing; in addition, hydrogen produced and not consumed in a first pass through the reaction zone of steam processing may be reused after separation and compression to the same reaction zone or used further downstream or in other zones within the facility.

In other aspects, the present disclosure also relates to removing sulfur from oxidized organo-sulfur hydrocarbons, and in particular from sulphones and sulfoxides.

Sour crude oil is crude oil containing a high amount of sulfur. It is common to find crude oil containing some sulfur. When the total sulfur level in the oil is more than 0.5% sulfur (by weight), the oil is called “sour”. Oil with less than 0.5% sulfur (by weight) is called “sweet”.

The inventors have realised that: oxidized oil can be treated to remove the sulfur and the oxygen to yield desulfurized hydrocarbons. Therefore, when the raw feedstock, such as, but not limited to, gasoil or diesel feedstocks, contains non-oxidized sulfur-containing compounds, oxygen may be first added to oxidize the raw materials to form oxidized sulfur-containing hydrocarbons.

The oxidized hydrocarbons can then be processed by a combination of hydroprocessing with hydrogen, and steam to produce processing deoxidized/desulfurized hydrocarbons.

Replacing hydrogen by generating it in situ from steam within the reaction zone of hydrocarbons transformation reactions may be economical since 1 kg of H₂ cost around 2 USD whereas 1 kg of steam cost about 0.02 USD.

While the direct impact on emissions may be difficult to estimate, the energy levels of the reaction that generate hydrogen in industry (steam methane reforming) are much higher compared to the generation of hydrogen in situ via catalytic steam cracking.

Various aspects of the present disclosure will now be described with reference to the figures. For the purposes of illustration, components depicted in the figures are not necessarily drawn to scale. Instead, emphasis is placed on highlighting the various contributions of the components to the functionality of various aspects of the present disclosure. A number of possible alternative features are introduced during the course of this description. It is to be understood that, according to the knowledge and judgment of persons skilled in the art, such alternative features may be substituted in various combinations to arrive at different embodiments of the present disclosure.

### Catalytic Steam-Hydro Upgrading

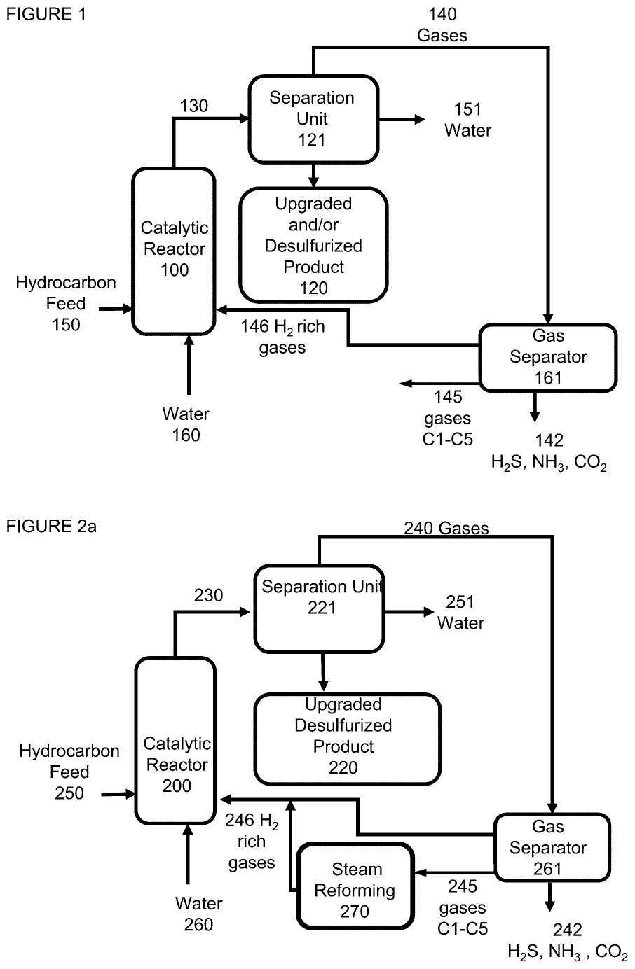

As shown in FIG. 1, the reactor feed 150, which may be bio-oil, bitumen or heavy oil (topped or not), and/or oxidized hydrocarbon, is reacted in the presence of a solid catalyst within catalytic reactor 100 (FIG. 1) to enable the catalytic upgrading and desulfurization/denitrogenation. Water or steam 160 is injected into the reactor, as well as hydrogen (e.g., recycled 146 or from another source).

Under suitable conditions and in the presence of the catalyst, a reactor output stream 130 comprising an upgraded oil with reduced viscosity and increased API gravity. In addition, the process may also remove non-carbon, non-hydrogen molecules from organic molecules within the hydrocarbon feed. For example, sulfur free (or sulfur reduced) effluent may be formed in which sulfones (or other sulfur and/or nitrogen containing compounds) may be partially or totally decomposed, for example, forming H₂S and/or SO₂ molecules.

Partial upgrading of the heavy oil and bitumen is possible since reactions II-III and VI-VII can take place in the catalytic reactor by combining the steam processing and hydroprocessing catalyst.

The present disclosure relates to performing both these processes in the same reactor vessel simultaneously in the presence of two different catalysts: a hydroprocessing catalyst and a steam processing catalyst. In this case, each of the hydroprocessing and steam processing catalysts are each mounted directly onto an underlying support (e.g., as opposed to one of the catalysts being impregnated in or mounted onto the other catalyst).

Performing these processes within the same reactor chamber has been difficult in the past because many of the catalysts used to facilitate the hydroprocessing reaction (e.g., metal sulfides) are deactivated in the presence of water. This has meant that systems have been designed to use either one process or the other.

In contrast, the inventors have realised that, for hydroprocessing catalysts that are impervious to the presence of water, such as ones described herein, the two processes may be carried out simultaneously.

In addition, when hydroprocessing and steam processing catalysts are both present in the catalytic reactor, hydrogen is produced on the surface of the steam processing catalyst by water splitting. This produced hydrogen may be used directly as part of the steam processing reaction or combined to form H₂ which can then be activated on the hydroprocessing catalyst. In this way, there is less hindering to the production of H₂ due to reverse water shift and the H₂ can be effectively used for hydrogenating/hydroprocessing reactions.

Using both processes may allow a synergy in the system to more efficiently utilizing the hydrogen produced by the water splitting within the hydroprocessing reactions.

The reactor output stream 130 is then separated in a separation unit 121 to produce water 151, an enhanced hydrocarbon product, in this case, an upgraded and/or desulfurized product 120 and a gas stream 140.

The gas stream 140 is then separated in a gas separator 161 into waste gases 142 (e.g., including one or more of H₂S, NH₃, CO₂), a hydrogen stream 146 which is recycled to the reactor vessel, and a light hydrocarbon stream 145. It will be appreciated that the separated water 151 may also be recycled as feed water 160 for the reactor vessel.

### Catalytic Steam-Hydro Desulfurization

The system of FIG. 1 may also be used to remove unwanted elements from the hydrocarbon feed (e.g., sulfur, nitrogen and oxygen).

For oxidized hydrocarbon feeds, there are a number of possible methods of removing oxygen and sulfur from the oxidized stream containing sulfone and sulfoxides.

One of these methods include hydroprocessing the sulfone and/or sulfoxides, R′—S(O)ₓ—R″, with hydrogen to generate hydrocarbons and sulfur oxide, SOₓ:

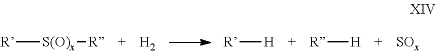

It will be appreciated that R′ and R″ may be alkyl and/or aryl groups. In some cases, R′ and R″ may be bonded together. It will also be appreciated that x=1 corresponds to the reaction for a sulfoxide, and x=2 corresponds to the reaction for a sulfone.

Another method of removing oxygen and sulfur from the sulfone and sulfoxides is steam processing which involves reacting the sulfone and/or sulfoxides, R′—S(O)ₓ—R″, with water to generate hydrocarbons and sulfur oxides, SO_{y+1}:

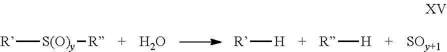

The present technology may involve performing both these methods in the same reactor vessel simultaneously in the presence of two different catalysts: a hydroprocessing catalyst and a steam processing catalyst. In this case, each of the hydroprocessing and steam processing catalysts are each mounted directly onto separated underlying supports which may be the same type of support or different (e.g., as opposed to one of the catalysts being impregnated on or mounted onto the other catalyst).

For non-oxidized sulfur/nitrogen containing compounds the reaction would be similar as for hydrotreating, except that, because of the steam processing catalyst they can take place with the hydrogen produced by the reaction (and recycled) in the presence of steam. For example, for sulfur, the hydrogen may be reacted with the non-oxidised sulfur containing hydrocarbon to produce an enhanced hydrocarbon and hydrogen sulfide (reaction I above is a specific example of this):

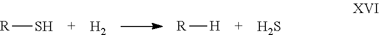

Performing these processes within the same reactor chamber has been difficult in the past because many of the catalysts used to facilitate the hydroprocessing reaction (e.g., metal sulfides) are deactivated in the presence of water. In the past, this has meant that systems have been designed to use either process but not combined in the same reactor.

In contrast, the inventors have realised that, for hydroprocessing catalysts that are impervious to the presence of water, the two processes may be carried out simultaneously inside the same reactor.

Using both processes may allow the system to more completely desulfurize a mixed feedstock because, for individual compounds, one or other of the processes may be more suited to facilitate the removal of sulfur from each individual compound.

In addition, as shown above, both hydroprocessing and steam processing of oxidized feeds generates sulfur oxides (SOₓ) which can bind to catalyst sites, eventually deactivating the catalyst. One method of cleaning the catalyst sites (cat) is to inject hydrogen which reacts with the sulfur oxides, either in the gas stream or bound to the catalyst, to form hydrogen sulfide and water (e.g., in the form of steam):

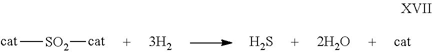

It will be appreciated that this cleaning reaction involves two of the reactants used in the two desulfurizing methods described above. The catalyst cleaning reaction uses hydrogen as a reactant, which is a reactant in the hydroprocessing reaction, and produces water, which is a reactant in the steam processing reaction working in this way concomitantly.

Therefore, if the system was set up just for hydroprocessing using previously available water-sensitive catalysts, the cleaning reaction would use some of the reactant and generate a product, water, which may denature the catalyst in another way. Likewise, if the system was set up just for steam processing, the hydrogen would only be used for catalyst cleaning.

In the present disclosure, because both hydroprocessing and steam processing is facilitated within the same reactor vessel, the hydrogen can perform two functions: for hydroprocessing and for cleaning sulfur dioxide created by both processes from the catalysts. And any hydrogen which forms water through the cleaning process can then be used in the steam processing of further oxidized sulfurized hydrocarbons.

That is, for upgrading as well as for desulfurization of oxidized hydrocarbons, the combination of active catalysts is possible as long as the hydrogenating catalyst is not susceptible to water, which eliminates many commonly used active phases for hydrogenation and hydrotreating which deactivate in the presence of water. The present technology enables oxidative desulfurization by steam using water insensitive catalysts (e.g., an active phase of molybdenum carbide and/or tungsten carbide in conjunction with the water dissociating active phases). Suitably prepared molybdenum carbide and/or tungsten carbide catalysts are not affected by the presence of water, which allows them to be used in conjunction with the present technology.

As shown in FIG. 1, subsequent to the catalytic reaction, a reactor output stream 130 comprising upgraded and/or desulfurized hydrocarbon is subjected to gas/liquid separation using product separation unit 121 resulting in upgraded/desulfurized product 120, gases 140 and water 151. The product water 151 may also be recycled to the catalytic reactor (e.g., as water reactant 160).

In this embodiment, the separated gases 140 include sulfur containing gases (e.g., H₂S), carbon dioxide, hydrogen and light hydrocarbons.

The gases 140 are separated 161 to produce a H₂ rich gases 146 plus light gaseous hydrocarbon 145. The hydrogen rich stream 146 according in this embodiment is recirculated to the catalytic reactor 100. The remaining gases form a non-recycle stream (142 and 145).

Recycling the hydrogen to the catalytic reactor means that the hydrogen can be used as a reactant for the hydroprocessing and/or catalytic cleaning reactions.

### Catalytic Steam-Hydro Denitrogenation

The system of FIG. 1 may also be used for denitrogenation. For denitrogenation of pre-oxidized nitrogen containing hydrocarbons, similar reactions as for sulfur can be written. Nitrogen oxides may be reacted in the presence of the catalysts (e.g., the hydroprocessing catalysts) to form water and ammonia, and oxidised nitrogen containing hydrocarbons may be reacted with hydrogen to form hydrocarbons and nitrogen oxides. Likewise, the steam processing catalyst may facilitate a reaction between oxidised nitrogen containing hydrocarbons and steam to form enhanced hydrocarbons and nitrogen oxides. For example:

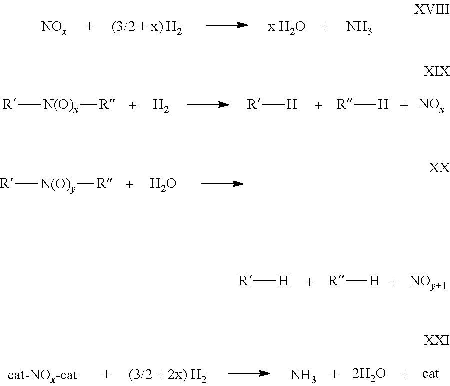

For nitrogen, the hydrogen may be reacted with the non-oxidised nitrogen containing hydrocarbon to produce an enhanced hydrocarbon and ammonia:

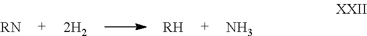

A specific example of this is:

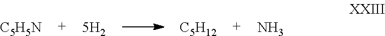

In this case, the non-oxidised nitrogen containing hydrocarbon is a heterocyclic organic compound, specifically a pyridine. Other non-oxidised nitrogen containing hydrocarbons may comprise primary, secondary or tertiary amines.

### Steam Reforming

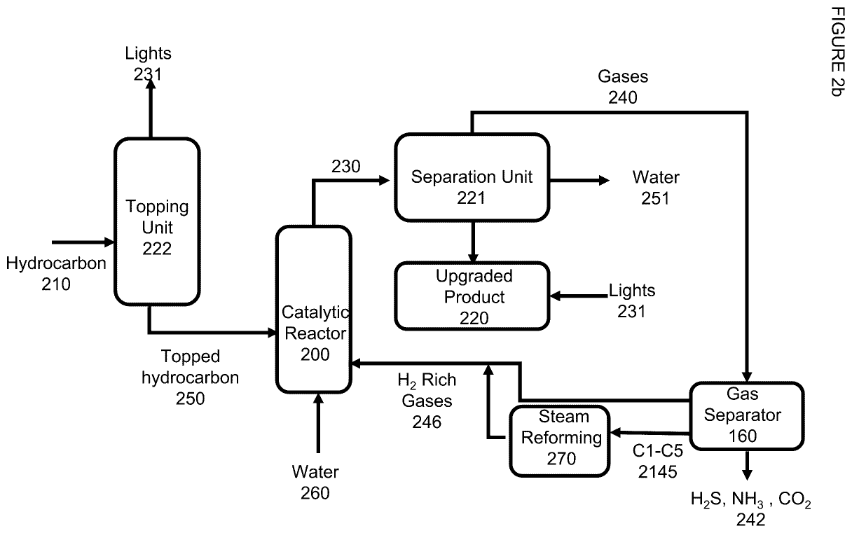

FIG. 2a is an alternative embodiment for the enhancing a received bio-oil heavy oil or bitumen hydrocarbon feed, and/or oxidized sulfurized hydrocarbons. Like the embodiment of FIG. 1, the apparatus comprises a catalytic reactor 200 comprising hydroprocessing and steam processing catalyst. The catalytic reactor in this case is the same or similar to that described in relation to FIG. 1.

Water 260 and a bio-oil, heavy oil or bitumen, and/or oxidized hydrocarbons feed 250 are injected into the catalytic reactor 200 to form a product feed 230 comprising an enhanced oil and waste gases. These are separated using the product separation unit 221 to provide a gas stream 240, a water stream 251 and an upgraded/desulfurized product stream 220.

The gases are separated in a gas separator 261 into a recycle stream containing hydrogen 246 and a light hydrocarbon stream 245 and a non-recycle stream 242 containing sulfur containing gas (e.g., H₂S) and possibly other waste gases (e.g., NH₃ and CO₂).

However, in this embodiment, the light gaseous hydrocarbon stream 245 is subjected to steam reforming 270 to convert most of the light hydrocarbons into hydrogen. Steam reforming reacts light hydrocarbons with steam to form hydrogen and carbon monoxide:

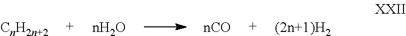

Or more generally:

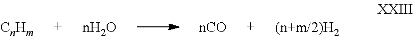

Steam reforming can be carried out on a range of hydrocarbons, e.g., with carbon chain lengths up to 5 (pentane). It will be appreciated that the product separation unit 221 and/or gas separator 261 may be adjusted to control the hydrocarbons which form part of the recycle stream 245. For example, the system may be configured such that only methane (n=1) is recycled to the steam reformer 270. For other feedstocks, the heavier hydrocarbons may be recycled (e.g., n may be as high as 5).

As shown above, the steam reforming generates additional hydrogen from the light hydrocarbons to form a hydrogen-rich gas stream 246 which is then recirculated to the catalytic reactor 200. In this way, the process produces all the hydrogen needed for hydroprocessing reactions.

In some embodiments, the output of the steam reformer 270 may be fed into the gas separator 260.

FIG. 2b shows an adapted system of FIG. 2a. The system of FIG. 2b is the same as that of FIG. 2a, with the addition of a topping unit 222. The hydrocarbon feed (bio-oil bitumen or heavy oil) 210 is first topped to produce a topped hydrocarbon 250 and a light hydrocarbon fraction 231. The topped hydrocarbon 250 is then treated in the catalytic reactor 200, and the light fraction 231 is combined with the enhanced hydrocarbon product from reactor 200 to form the final upgraded product 220.

### System Parameters

In some embodiments of the present disclosure, the upgraded oil 120, 220 produced by these systems may have viscosities as low as 50 cP, and API gravity as high as 30°.

The sulfur content in desulfurized fossil fuel 120, 220 produced by these systems may be as low as 10 ppm for distillate fuels, in certain embodiments less than 1% by weight, for fossil fuels. In some embodiments, the sulfur content may be less than 0.5, 0.1 or 0.05 wt. %.

In general, the operating temperature for the catalytic reactor 100, 200 may be between 250° C. to 500° C., e.g., 300° C. to 400° C. or 320° C. to 380° C.

The system may be configured to adjust the reaction conditions (e.g., temperature, pressure and/or space velocity) of the catalytic reactor based on the feedstock. For example, the system may be configured to increase the temperature of the reactor in response to detecting that the feedstock is a heavier oil and reduce the temperature of the reactor in response to detecting that the feedstock is a lighter one. Determining the weight of the oil can be done in a variety of ways including measuring the viscosity of the feedstock. The system may be configured to adjust the reaction conditions of the reactor based on the presence, or amount, of non-carbon, non-hydrogen elements in the hydrocarbon feedstock.

Operating conditions for the catalytic reactor 100, 200 may also comprise one or more of:
a catalytic decomposition pressure in the range of from about 250 psig to about 1200 psig (in certain cases about 400 psig to 500 psig) and
a Weight Hourly Space Velocity (WHSV) in the range from about 0.1 h⁻¹ to about 10 h⁻¹ (in certain cases about 0.1 h⁻¹ to 4 h⁻¹ or about 0.2 h⁻¹ to about 2 h⁻¹.

In addition, the recirculated H₂ 146, 246 to oil ratio is in the range of from about 20 std.cm³/cm³ of oil to about 200 std.cm³/cm³ of oil, and in certain embodiments from about 90 std.cm³/cm³ of oil to about 150 std.cm³/cm³ of oil.

### Catalysts

The hydroprocessing catalyst may be selected from: Metallic carbides, oxy-carbides, nitrides and phosphides and mixtures thereof. The hydroprocessing catalyst may be comprise one or more of: MO₂C, Mo_{z}OₓC_{y}, and Mo_{z}OₓCₘNₒ where z, x, y, n, m and o can be any number. The hydroprocessing catalyst may be comprise one or more of: W₂C, W₂OₓC_{y}, W₂OₙCₘNₒ where z, x, y, n, m and o can be any number.

The steam processing catalyst may be bi-, tri-, tetra or penta-metallic oxides combinations having elements from the groups 1 and 2 including Na, K, Cs, Ca, Mg or Ba; elements from the groups 4, 5, 6 7, 8, 9 10, 11 including Ti, V, Cr, Mn, Fe, Co, Ni, Cu, Mo, Zr or Ce and elements from the 13, 14, 15 including Al, Si.

Examples of the steam processing catalysts include hydrotalcites precursors or mixed oxides or combination of mixed oxides:

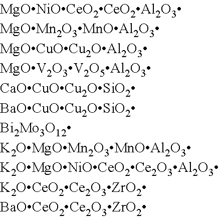

Another set of catalysts for this process, including those for hydroprocessing, can be prepared with the same suite of active components described above, using solid supports such as alumina, silica and/or kaolin (e.g., modified kaolin) with controlled textural properties (surface area and porosity are preferably in the range between 30 and 400 square meters/g and 6-50 nm, respectively).

In the catalytic reactor the hydroprocessing catalyst and the steam processing catalyst may be either separated or blended.

The proportion of steam processing catalyst may be from about 5 wt. % to about 95 wt. %, the rest being a hydroprocessing catalyst. In other embodiments, the steam processing catalyst as a proportion of the total hydroprocessing and steam processing catalysts may be from 50 wt. % to about 90 wt. %.

### Preparing the Catalysts

The catalyst bed may be produced by:
distributing a hydroprocessing catalyst precursor and a steam processing catalyst precursor on a support, and
calcining/pyrolyzing and activating the hydroprocessing catalyst precursor and the steam processing catalyst precursor at the same time to form a hydroprocessing catalyst and a steam processing catalyst.

This process of arranging the catalyst on the support may occur in fewer steps than would be the case if a first catalyst (e.g., the steam processing catalyst) was laid down and calcined, and then a second catalyst (e.g., the hydroprocessing catalyst) was impregnated into the already calcined catalyst.

This process may result in the hydroprocessing catalyst and the steam processing catalyst being each mounted directly onto the underlying support.

The process may comprise successive or co-impregnation of precursor solutions of the active metals followed by drying and calcination to form the corresponding catalytic metal oxides. These catalysts may have similar performance, reduced costs and a lower environmental impact in terms of generation of metal contaminated aqueous effluents. The dispersion of the precursors may be enhanced by acidification of the solid support.

### EXAMPLES

The following examples provide experimental evidence for the present disclosure and are presented to illustrate and demonstrate specific features or conditions for the practice of the present disclosure and should not be interpreted as a limitation upon the scope of the present disclosure.

### Catalytic Steam-Hydro Upgrading Examples

### Example 1

This example shows the effectiveness of the process in the upgrading of a bitumen. Table 1 shows the properties of the bitumen.

TABLE 1
Properties of Bitumen

| | |
|---|---|
| Density at 15.6° C. (g/cm³) | 0.975 |
| API (°) | 13.7 |
| Viscosity at 25° C. (Cp) | 4795 |
| MCR (wt. %) | 10.69 |
| Sulfur (wppm) | 43515 |
| Nitrogen (wppm) | 2546 |
| TAN (mg KOH/g) | 0.759 |

TAN = Total Acid Number.
MCR = Micro carbon residue

The catalytic steam-hydroprocessing conditions used for examples 1.1 and 1.2 are shown in table 2.

TABLE 2
Operating conditions for catalytic steam-hydroprocessing
of upgrading of Bitumen examples.

| | |
|---|---|
| Temperature (° C.) | 370-380 |
| Pressure (psig) | 440 |
| H₂O (wt. %) | 5 |
| SPC:HDPC Catalysts Ratio(wt/wt) | 1.9 |
| WHSV(h⁻¹) | 0.2 |
| H₂:HC ratio at STP (v/v) | 120 |

### Example 1.1

Table 3 presents the characteristics of the upgraded and corresponding Bitumen.

TABLE 3
Characteristic of the bitumen and corresponding upgraded product.

| | | Viscosity | | | TAN | |
|---|---|---|---|---|---|---|
| | | at 25° C. | Sulfur | Nitrogen | (mg | MCR |
| | API(°) | (cP) | (wppm) | (wppm) | KOH/g) | (wt. %) |
| Bitumen | 13.7 | 4795 | 43515 | 2546 | 0.759 | 10.7 |
| Upgraded | 14.7 | 1204 | 36037 | 2447 | 0 | 9.9 |
| Bitumen | | | | | | |
| processed | | | | | | |
| at 370° C. | | | | | | |
| Upgraded | 16.5 | 373 | 33237 | 2418 | 0 | 9.2 |
| Bitumen | | | | | | |
| processed | | | | | | |
| at 380° C. | | | | | | |

Analyses of liquid products show a decrease of viscosity (92.2% for 380° C.), up to 23.6% reduction in sulfur content, reduction of MCR and up to 2.8-point increase in API gravity. In addition, a complete elimination of Total Acid Number (TAN) is observed. These results show the enhancement of the products obtained by one of the possible applications of the technology.

### Example 1.2

This example shows the effectiveness of the process in the upgrading of a topped bitumen corresponding to the configuration described in FIG. 2b. Table 1 shows the properties of the topped Bitumen and the corresponding light fraction.

TABLE 4
Characteristics of the topped bitumen used in this
example, and the corresponding light fraction.

| | Topped (218° C.⁺) | Light (218° C.⁻) |
|---|---|---|
| Density at 15.6° C. (g/cm³) | 0.996 | 0.854 |
| API (°) | 10.6 | 33.6 |
| Sulfur (wppm) | 43515 | 9311 |
| Fraction wt. % | 87.8 | 12.2 |

Topped fraction was treated utilizing the conditions indicated in table 2. The product of the catalytic steam-hydroprocessing was mixed with the corresponding proportion of light fraction to produce the upgraded bitumen. Table 5 shows the characteristics of the obtained upgraded bitumen.

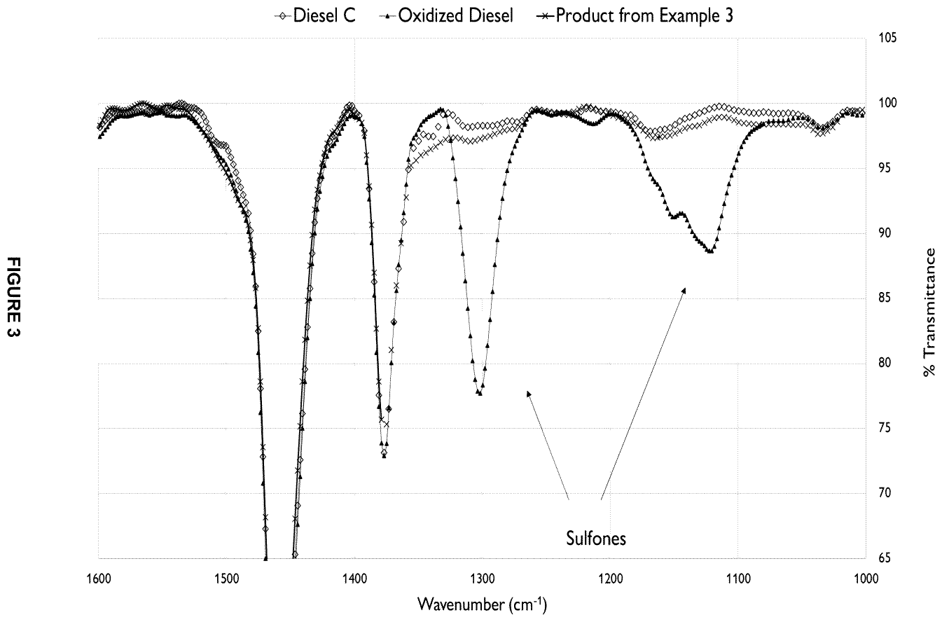

TABLE 5
Characteristic of the bitumen and corresponding
upgraded product applying one of the embodiments
of the present disclosure as shown in FIG. 3.

| | | Viscosity at | Sulfur | TAN | MCR |
|---|---|---|---|---|---|
| | API(°) | 25° C. (cP) | (wppm) | (mgKOHg) | (Wt. %) |
| Bitumen | 13.7 | 4795 | 43515 | 0.759 | 10.7 |
| Upgraded | 16.4 | 487 | 29240 | 0 | 8.9 |
| Bitumen | | | | | |
| processed | | | | | |
| at 370° C. | | | | | |
| Upgraded | 19.4 | 221 | 27868 | 0 | 8.5 |
| Bitumen | | | | | |
| processed | | | | | |
| at 380° C. | | | | | |

Liquid products showed a decrease of viscosity (95.4% for 380° C.), up to 36.0% reduction in sulfur content, reduction of MCR and up to 5.7-point increase in API gravity. Acidity was dropped to 0. These results show the enhancement of the products obtained by one of the possible applications of the technology of the present disclosure.

### Catalytic Steam-Hydro Desulfurization

### Example 2

This example shows the effectiveness of the process in the desulfurization of an oxidized diesel (A). Table 6 shows the properties of Diesel A.

TABLE 6
Properties of Diesel A

| | Value |
|---|---|
| Property | |
| API Gravity (°) | 30.6 |
| Total Sulfur (ppmw) | 5268 |
| Total Nitrogen (ppmw) | 99 |
| Distillation Curve | |
| IBP | 168.9 |
| 5 | 198.3 |
| 10 | 222.0 |
| 15 | 235.6 |
| 20 | 248.8 |
| 25 | 259.1 |
| 30 | 267.8 |
| 35 | 276.0 |
| 40 | 284.0 |
| 45 | 291.0 |
| 50 | 297.2 |
| 55 | 303.0 |
| 60 | 308.7 |
| 65 | 314.1 |
| 70 | 319.4 |
| 75 | 324.8 |
| 80 | 330.2 |
| 85 | 335.6 |
| 90 | 341.7 |
| 95 | 349.3 |
| EBP | 366.8 |

The catalytic steam-hydroprocessing conditions used for examples 2.1 to 2.3 are shown in table 7.

TABLE 7
Operating conditions for examples 2.1, 2.2 and 2.3.

| | Example 2.1 | Example 2.2 | Example 2.3 |
|---|---|---|---|
| Temperature/° C. | 365 | 365 | 395 |
| Pressure(psig) | 440 | 440 | 440 |
| WHSV(h⁻¹) | 0.2 | 0.2 | 0.1 |
| H₂:HC ratio/normal(v/v) | — | — | 120 |
| SPC:HDPC Catalyst | 1.9 | 1.9 | 1.9 |
| Ratio(wt/wt) | | | |

The feed used in examples 2.2 and 2.3 were oxidized prior to the catalytic steam-hydro processing in a continuous flow ultrasonic reactor using hydrogen peroxide as oxidant and formic acid as catalyst. Conditions utilized for the oxidation are shown in table 8.

TABLE 8
Operating conditions for the oxidation of
feedstock used in examples 2.2 and 2.3.

| | |
|---|---|
| H₂O₂:S (molar ratio) | 15 |
| Residence time (min) | 3 |
| Ultrasound amplitude (μ) | 20 |
| Pressure (psig) | 5 |

### Example 2.1

In order to show the effectiveness of the process diesel A was first treated without a prior oxidation, at the conditions shown in table 2. The characteristics of the product obtained are presented in table 9. 34.3 wt % desulfurization was observed for this case.

TABLE 9
Product characteristics.

| Property | Value |
|---|---|
| API Gravity(°) | 31.2 |
| Sulfur (wppm) | 3460 |

### Example 2.2

For this example, diesel A was pre-oxidized using an ultrasound processor, using conditions indicated in table 8, and the oil phase was separated and treated in the steam-hydroprocessing catalytic reactor. Product characteristics are shown in table 10. 67.2 wt % desulfurization was obtained for this case.

TABLE 10
Product characteristics.

| Property | Value |
|---|---|
| API Gravity (°) | 31.2 |
| Sulfur (wppm) | 1729 |

### Example 2.3

In this case, diesel A was pre-oxidized using conditions indicated in table 8, the oil phase was separated and treated in the steam-hydroprocessing catalytic reactor with hydrogen recycling at the conditions reported in table 7. Product characteristics are shown in table 11. 93.9 wt % desulfurization and 90.9 denitrogenation was obtained for this case.

TABLE 11
Product characteristics.

| Property | Value |
|---|---|
| API Gravity (°) | 33 |
| Sulfur (wppm) | 322 |
| Nitrogen (wppm) | 9 |

### Example 3

This example shows the effectiveness of the process in the desulfurization of an oxidized diesel (B). Table 12 shows the properties of Diesel B.

TABLE 12
Properties of Diesel B

| | Value |
|---|---|
| Property | |
| API Gravity (°) | 42.3 |
| Total Sulfur (ppmw) | 8590 |
| Total Nitrogen (ppmw) | 211 |
| Distillation Curve (° C.) | |
| IBP | 164.8 |
| 5 | 167.3 |
| 10 | 169.4 |
| 15 | 172.0 |
| 20 | 174.3 |
| 25 | 177.0 |
| 30 | 183.7 |
| 35 | 191.2 |
| 40 | 197.7 |
| 45 | 212.0 |
| 50 | 220.6 |
| 55 | 231.6 |
| 60 | 243.8 |
| 65 | 256.2 |
| 70 | 270.6 |
| 75 | 286.6 |
| 80 | 303.7 |
| 85 | 324.9 |
| 90 | 353.6 |
| 95 | 401.7 |
| EBP | 519.1 |

The catalytic steam-hydroprocessing conditions used for examples 3.1 and 3.2 are shown in table 13.

TABLE 13
Operating conditions for examples 3.1, 3.2.

| | Example 3.1 | Example 3.2 |
|---|---|---|
| Temperature (° C.) | 375 | 385 |
| Pressure (psig) | 440 | 440 |
| WHSV (h⁻¹) | 0.2 | 0.1 |
| H₂:HC ratio/normal(v/v) | — | 120 |
| SPC:HDPC Catalyst Ratio (wt/wt) | 1.9 | 1.9 |

The feed used in examples 3.1 and 3.2 were oxidized prior to the catalytic steam-hydro processing in a continuous flow ultrasonic reactor using hydrogen peroxide as oxidant and formic acid as catalyst. Conditions utilized for the oxidation are shown in table 14.

TABLE 14
Operating conditions for the oxidation of
feedstock used in examples 3.1 and 3.2.

| | |
|---|---|
| H₂O₂:S (molar ratio) | 10 |
| Residence time (min) | 3 |
| US amplitude (μ) | 30 |
| Pressure (psig) | 5 |

### Example 3.1

For this example, diesel B was pre-oxidized using conditions indicated in table 8, and the oil phase was separated and treated in the steam-hydroprocessing catalytic reactor without hydrogen addition. Product characteristics are shown in table 15. 78.8 wt % desulfurization was obtained for this case.

TABLE 15
Product characteristics.

| Property | Value |
|---|---|
| API Gravity (°) | 42.5 |
| Sulfur (wppm) | 1909 |

### Example 3.2

In this case, diesel B was pre-oxidized using conditions indicated in table 14, the oil phase was separated and treated in the steam-hydroprocessing catalytic reactor with hydrogen recycling at the conditions reported in table 13. Product characteristics are shown in table 16. 96.1 wt. % desulfurization and 96.2 wt. % denitrogenation was obtained for this case.

TABLE 16
Product characteristics.

| Property | Value |
|---|---|
| API Gravity (°) | 44.9 |
| Sulfur (wppm) | 335 |
| Nitrogen (wppm) | 8 |

### Example 4

This example shows the effectiveness of the process in the desulfurization of an oxidized diesel (C). Table 17 shows the properties of Diesel C.

TABLE 17
Properties of Diesel C

| | Value |
|---|---|
| Property | |
| API Gravity (°) | 20.7 |
| Total Sulfur (ppmw) | 24526 |
| Total Nitrogen (ppmw) | 477 |
| Distillation (° C.) | |
| IBP | 180.4 |
| 5 | 225.9 |
| 10 | 245.1 |
| 15 | 256.5 |
| 20 | 265.7 |
| 25 | 272.6 |
| 30 | 280.9 |
| 35 | 287.5 |
| 40 | 291.0 |
| 45 | 298.0 |
| 50 | 302.4 |
| 55 | 306.1 |
| 60 | 310.3 |
| 65 | 314.1 |
| 70 | 317.8 |
| 75 | 321.7 |
| 80 | 326.1 |
| 85 | 330.4 |
| 90 | 334.2 |
| 95 | 340.9 |
| EBP—End Boiling Point | 353.1 |

The catalytic steam-hydroprocessing conditions used for the treatment of this diesel are shown in table 18.

TABLE 18
Operating conditions for example 4.

| | |
|---|---|
| Temperature (° C.) | 395 |
| Pressure (psig) | 440 |
| WHSV (h⁻¹) | 0.1 |
| H₂:HC ratio/normal(v v⁻¹) | 600 |
| SPC:HDPC Catalysts Ratio(wt/wt) | 1.9 |

The feed used in this case was oxidized prior to the catalytic steam-hydro processing in a continuous flow ultrasonic reactor using hydrogen peroxide as oxidant and formic acid as catalyst. Conditions utilized for the oxidation are shown in table 19.

TABLE 19
Operating conditions for the oxidation
of feedstock used in example 4.

| | |
|---|---|
| H₂O₂:S (molar ratio) | 5 |
| Residence time (min) | 3 |
| US amplitude (μ) | 30 |
| Pressure(psig) | 5 |

For this example, diesel C was pre-oxidized using conditions indicated in table 19, and the oil phase was separated and treated in the steam-hydroprocessing catalytic reactor with hydrogen addition. Product characteristics are shown in table 20. 10 points increase in API gravity, plus 98.9 wt. % desulfurization and 93.7 wt. % denitrogenation was obtained for this case.

TABLE 20
Product characteristics.

| Property | Value |
|---|---|
| API Gravity (°) | 30.6 |
| Sulfur (wppm) | 265 |
| Nitrogen (wppm) | 30 |

FIG. 3 shows the infra red spectra of: Diesel C, Oxidized Diesel C and the desulfurized product obtained using the present disclosure. The formation of sulfones after the oxidation is observed. The complete disappearing of the sulfones in the desulfurized hydrocarbon product obtained using the present disclosure is clearly seen.

### SPC and HDPC Catalysts Used in the Examples

Table 21 shows the nature and properties of SPC and HDPC catalysts used in the examples above.

TABLE 21
Properties of SPC and HDPC Catalysts

| Properties | SPC Catalyst | HDPC Catalyst |
|---|---|---|
| Shape | spheres | spheres |
| Size (mm) | 1.8 | 1.8 |
| BET* Surface area (m²/g) | 67.9 | 138.4 |
| Micro area (m²/g) | 8.6 | 28.5 |
| External area (m²/g) | 59.3 | 109.6 |
| BJH** Pore volume (cm³/g) | 0.4220 | 0.3784 |
| BJH** Pore size (nm) | 17.6 | 10.4 |
| Molybdenum carbide (% wt.) | — | 30.02 |
| Nickel Oxide (% wt.) | 5.73 | — |
| Magnesium Oxide (% wt.) | 7.79 | — |
| Aluminum Oxide (% wt.) | 71.21 | 69.98 |
| Cerium Oxide (% wt.) | 15.27 | — |

*Brunauer-Emmett-Teller
**Barrett-Joyner-Halenda

Although the present disclosure has been described and illustrated with respect to preferred embodiments and preferred uses thereof, it is not to be so limited since modifications and changes can be made therein which are within the full, intended scope of the present disclosure as understood by those skilled in the art.

1-31. (canceled)

32. A process for enhancing a hydrocarbon feed, the process comprising;
processing the hydrocarbon feed with steam in a catalytic reactor to form an enhanced fuel, the catalytic reactor comprising a combination of both a hydroprocessing catalyst and a steam processing catalyst, the hydroprocessing catalyst and the steam processing catalyst each being mounted directly onto a respective underlying support;
wherein the steam processing catalyst is a water splitting catalyst which facilitates breaking of hydrogen-oxygen bonds in water to produce hydrogen, and
wherein the hydroprocessing catalyst facilitates a reaction between the produced hydrogen and the hydrocarbon feed to produce hydrocarbon products.

33. The process according to claim 32, wherein the hydrocarbon feed comprises higher molecular weight hydrocarbons, and wherein the hydroprocessing catalyst facilitates an upgrading reaction between the produced hydrogen and the higher molecular weight hydrocarbons to produce lower molecular weight hydrocarbon products.

34. The process according to claim 32, wherein the hydrocarbon feed comprises oxidised nitrogen-containing hydrocarbons, and wherein the hydroprocessing catalyst facilitates a reaction between the produced hydrogen and the oxidised nitrogen-containing hydrocarbons to produce the hydrocarbon products and nitrogen oxide.

35. The process according to claim 32, wherein the hydrocarbon feed comprises non-oxidised nitrogen-containing hydrocarbons, and wherein the hydroprocessing catalyst facilitates a reaction between the produced hydrogen and the non-oxidised nitrogen-containing hydrocarbons to produce the hydrocarbon products and ammonia.

36. The process according to claim 32, wherein the hydrocarbon feed comprises non-oxidised sulfur-containing hydrocarbons, and wherein the hydroprocessing catalyst facilitates a reaction between the produced hydrogen and the non-oxidised sulfur-containing hydrocarbons to produce the hydrocarbon products and hydrogen sulfide.

37. The process according to claim 32, wherein the hydrocarbon feed comprises sulfones and/or sulfoxides, and wherein the steam processing catalyst catalyses a reaction between water and sulfones and/or sulfoxides to generate hydrocarbons and sulfur oxide.

38. The process according to claim 32, wherein the hydrocarbon feed comprises sulfones and/or sulfoxides, and wherein the hydroprocessing catalyst catalyses a reaction between hydrogen and sulfones and/or sulfoxides to generate hydrocarbons and sulfur oxide.

39. The process according to claim 32, wherein, compared with the hydrocarbon feed, the produced hydrocarbon products have one or more of: a lower nitrogen content; a lower viscosity; a lower Total Acid; a lower sulfur content; a lower micro carbon residue; a higher API gravity.

40. The process according to claim 32, wherein the hydroprocessing catalyst and the steam processing catalyst are mounted on separate beds within the catalytic reactor.

41. The process according to claim 32, wherein the hydroprocessing catalyst comprises a metallic carbide.

42. The process according to claim 32, wherein the hydroprocessing catalyst comprises one or more of: metallic oxy-carbides, metallic nitrides and metallic phosphides.

43. The process according to claim 32, wherein the hydroprocessing catalyst comprises one or more of: molybdenum and tungsten.

44. The process according to claim 32, wherein the hydroprocessing catalyst comprises molybdenum carbide supported on an alumina support.

45. The process according to claim 32, wherein the hydroprocessing catalyst is impervious to water.

46. The process according to claim 32 wherein the steam processing catalyst comprises any one or a combination of:

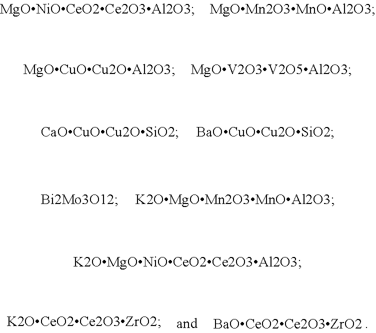

47. The process according to claim 32 wherein an output from the catalytic reactor is separated into a produced hydrocarbon stream and a gas stream, the gas stream comprising one or more of: sulfur containing gases, nitrogen containing gases, carbon dioxide, hydrogen, light hydrocarbons and water.

48. The process according to claim 47, wherein the gas stream is further separated into a recycle stream and a non-recycle stream, the recycle stream comprising one or more of: hydrogen and light hydrocarbons, and wherein the recycle stream is injected into the catalytic reactor.

49. The process according to claim 47, wherein the light hydrocarbons from the gas stream are reformed in a reforming vessel to produce additional hydrogen which is recycled to a reactor vessel of the catalytic reactor.

50. The process according to claim 32, wherein a proportion of steam processing catalyst as a proportion of the combination of the hydroprocessing catalyst and the steam processing catalyst is between 50 wt. % and 80 wt. %.

51. A catalytic reactor for enhancing a hydrocarbon feed, the catalytic reactor comprising;
a hydroprocessing catalyst and a steam processing catalyst, the hydroprocessing catalyst and the steam processing catalyst each being mounted directly onto a respective underlying support within a reactor vessel;
wherein the steam processing catalyst is a water splitting catalyst which facilitates breaking of hydrogen-oxygen bonds in water to produce hydrogen, and
wherein the hydroprocessing catalyst facilitates a reaction between the produced hydrogen and the hydrocarbon feed to produce hydrocarbon products.

52. A process of manufacturing a catalyst bed for enhancing a hydrocarbon feed, the process comprising;
distributing each of a hydroprocessing catalyst precursor and a steam processing catalyst precursor on a respective underlying support,
activating the hydroprocessing catalyst precursor and the steam processing catalyst precursor at a same time to form a hydroprocessing catalyst and a steam processing catalyst;
wherein the steam processing catalyst is a water splitting catalyst which facilitates breaking of hydrogen-oxygen bonds in water to produce hydrogen, and
wherein the hydroprocessing catalyst facilitates a reaction between hydrogen and the hydrocarbon feed to produce hydrocarbon products.
